(19) United States
(12) Patent Application Publication
(10) Pub. No.: US 2011/0125866 A1
(43) Pub. Date: May 26, 2011

(54) HEALTH AND FITNESS DATA MANAGEMENT SYSTEM

(76) Inventor: MICHAEL C. WILLIAMS, Santa Barbara, CA (US)

(21) Appl. No.: 12/624,609

(22) Filed: Nov. 24, 2009

(51) Int. Cl. G06F 15/16; A63B 71/00

(52) U.S. Cl. 709/217; 482/8; 709/227

(57) ABSTRACT

According to various embodiments of the invention, devices and systems are provided that allow a user to retrieve health and fitness data from a variety of health and fitness devices. In some embodiments, a wireless communications module is configured to interface with the health and fitness devices to retrieve the generated health and fitness data. In these embodiments, the wireless communications module also interfaces with a mobile computing device allow the transfer of the health and fitness data to the mobile computing device. The mobile computing device may be configured to transmit or upload this data to one or more network locations, or to store and display representations of this data.

### TECHNICAL FIELD

The present invention relates generally to health and fitness, and more particularly, some embodiments relate to managing data generated by health and fitness related devices.

### DESCRIPTION OF THE RELATED ART

An increasing number of health and fitness related devices provide users with a large amount of performance data related to physical exercise. For example, heart rate monitors, pace monitors or pedometers, cycling computers, glucose meters, weight scales, blood pressure cuffs, physical training machines integrated with sensors, and other health and fitness sensor devices may be used to improve a user's health or physical conditioning. Many of these devices provide interfaces to allow data to be transferred from the device and stored or used for analysis. For example, a heart rate monitor might have a wireless communications interface that allows it to provide a user with a continuing update as to the user's heart rate via a health or fitness computer, for example in a watch form factor.

Maintaining a record of such data can be very useful in planning and assessing progress regarding physical condition. For example, trends in heart rate, weight, distance, power, speed, cadence, calories burned during an exercise period, and the other measurements that these devices provide can be helpful in planning future exercise workouts or regimens. Often these systems are equipped with various communications protocols and software methods to allow data transfer from the device to a central database or website. However, these systems are generally difficult to use. Moreover, different systems are typically equipped with different methods of uploading and aggregating data that are not interoperable. Often this lack of interoperability can impede a user's use of their health and fitness data. The lack of interoperability can also influence a user's decision on future health and fitness device purchases.

### BRIEF SUMMARY OF EMBODIMENTS OF THE INVENTION

According to various embodiments of the invention, devices and systems are provided that allow a user to retrieve health and fitness data from a variety of health and fitness devices. In some embodiments, a wireless communications module is configured to interface with the health and fitness devices to retrieve the generated health and fitness data. In these embodiments, the wireless communications module also interfaces with a mobile computing device to allow the transfer of the health and fitness data to the mobile computing device. The mobile computing device may be configured to transmit or upload this data to one or more central servers, or to store and display graphical representations of this data.

According to an embodiment of the invention, a computer program product comprising a computer useable medium having computer program code embodied therein is configured to enable a mobile computing device to interact with a health or fitness monitoring device or a plurality of health or fitness monitoring devices, the interaction comprising using a communications protocol module to establish a session with the health or fitness monitoring device; retrieving data from the health or fitness monitoring device during the session; storing the data on the mobile computing device; and uploading the data to a predetermined website.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates a system of data collection and storage according to an embodiment of the invention.

FIG. 2 illustrates a method of system operation according to an embodiment of the invention.

FIG. 3 illustrates an example of system operation in accordance with an embodiment of the invention.

FIG. 4 illustrates a communications module and mobile device configured in accordance with an embodiment of the invention.

FIG. 5 illustrates an example computing module that may be used in implementing various features of embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a system and method for managing health and fitness related data. In some embodiments, a communications module interfaces with a mobile communications device to provide a bridging system between a variety of health and fitness data generating devices and a centralized data server.

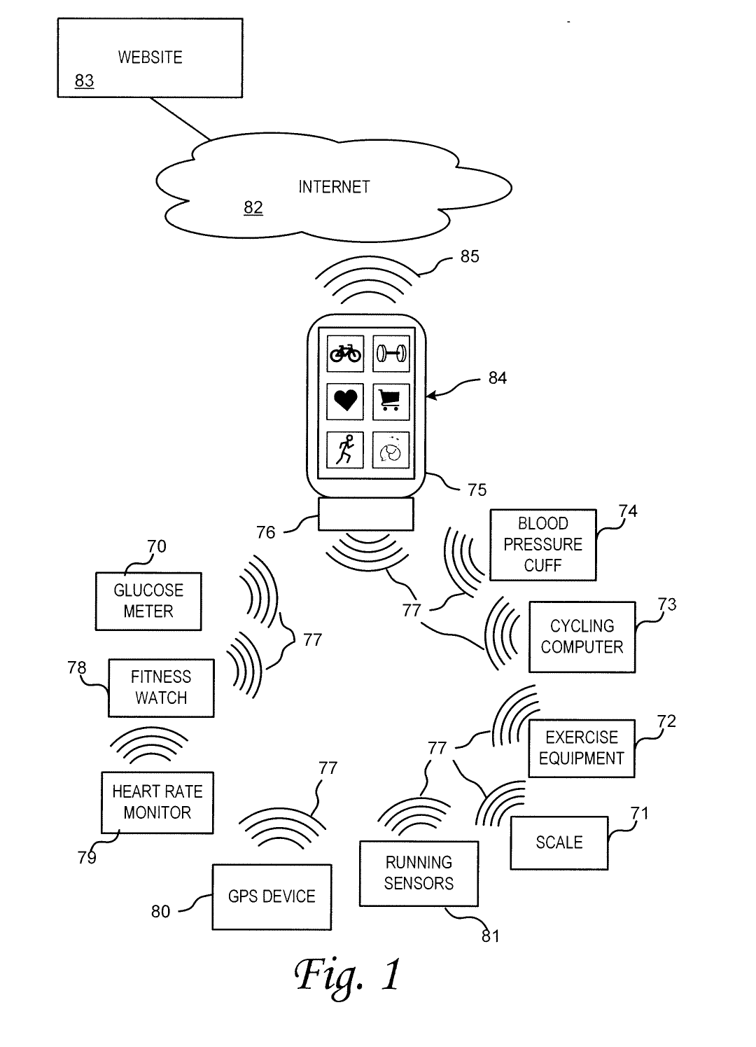

FIG. 1 illustrates a system of data collection and storage according to an embodiment of the invention. In this embodiment, a user may have access to a variety of health or fitness monitoring devices. Such health or fitness monitoring devices might comprise any health or fitness related computing device, sensor device, or monitoring device. For example, such devices might comprise a blood pressure monitoring or measuring device 74, a bicycling computer 73 coupled to various sensors, various exercise equipment 72, a scale 71, a running computer or related sensors 81, a GPS device 80, a heart rate monitor 79, a fitness watch 78, or a glucose meter 70. In one method of use, an athlete such as a runner may be equipped with a variety of data collecting devices during an exercise period, such as a pedometer 81, a GPS device 80, a heart rate monitor 79, and a fitness watch 78. These devices may be configured to determine various data generated during the exercise period, for example, the stride count, speed, distance, route taken, calories burned, or heart rate profile. In some instances, these devices may be configured to temporarily store data during the exercise period and then provide access to this data at a later point in time. For example, a GPS device 80 may be configured to store a route taken by a runner during a run, and then to provide that route to a computer storage device at a later point in time. Furthermore, some health or fitness monitoring devices may be pre-configured to interoperate before ultimate collection. For example, a fitness watch 78 may be configured to receive and collect data during an exercise period from other health or fitness monitoring devices, such as heart rate monitor 79, GPS device 80, or running sensors 81.

In the illustrated embodiment, a mobile computing device 75 may be equipped with one or more communications interfaces 76 to allow the device to communicate with the health or fitness monitoring devices and to communicate with an external computer network. For example, the mobile computing device may comprise a cellphone, such as a smartphone, or a PDA, that has a data connection to an external network such as the Internet 82 and the ability to load and execute computer programs via an operating system, which is housed in a mobile form factor. As a particular example, computing device 75 might comprise a smartphone running an operating system and may be configured to be programmed with an application that allows it to control interface 76 for communications with the health or fitness monitoring devices and to control a second interface to allow data collected from the health or fitness monitoring devices to be uploaded to an external data storage.

In this embodiment, interface 76 comprises a communications module that is configured to wirelessly communicate 77 with the health or fitness monitoring devices. In some embodiments, this communication may take place as the data is generated, for example, a pedometer 81 might continuously upload pace or stride data to the mobile device 75 during the exercise period. In other embodiments, the data may be stored by health or fitness monitoring device for a predetermined time or until a predetermined event occurs. For example, a fitness watch 78 might receive and store heart rate data from heart rate monitor 79 until the mobile device 75 transmits a request that the fitness watch 78 uploads the data.

In these embodiments, different health or fitness monitoring devices may be configured to communicate according to various protocols. For example, a cycling computer 73 might be equipped with various sensors, such as sensors used to determine speed, cadence, or power, and might be configured to wirelessly communicate according to a digital wireless ultra low power communications standard, such as the ANT+ protocol. Other health or fitness monitoring devices might be configured to communicate according to other communications standards. For example, a GPS device might be configured to wirelessly communicate according to the Bluetooth protocol. Accordingly, the communications module 76 may be configured to communicate according to a plurality of different communications protocols to provide the obtained data to the mobile device 75.

In addition to transmitting the obtained data to an external network or computer, some embodiments may be configured to allow display and data manipulation at the mobile device 75. For example, the application residing on the mobile device 75 may be configured to present the data 84 in addition to controlling the communications module 76 and providing the data uploading 85. For example, the data presentation 84 might comprise displaying a real-time listing of various data that is being collected, such as current heart rate, pace, calories per unit time, etc. . . . In other embodiment, the data presentation 84 might comprise using past data, for example to show trend lines, or providing calculations based on accumulated date. For example, the various data streams and sources could be integrated to provide data correlations, such a weight trend compared to blood pressure compared to calories burned per unit time. In such an example, the presentation 84 might comprise simultaneously displaying these trends and their correlations to allow system user to monitor progress.

In the illustrated embodiment, the mobile device 75 is configured to upload 85 the received data to the internet 82 for storage at a server hosting a website 83. In other embodiments, the data may be uploaded 85 to a variety of additional locations. In some embodiments, the upload procedure might comprise uploading the data to the external storage in real time as the data is generated. In other embodiments, this data might be uploaded in other manners, such as in a periodic manner where batches of generated data are periodically uploaded. In other embodiments, in addition to—or as an alternative to—the website 83, the mobile device may be configured to transmit the data to another mobile device, to a locally connected computer, or to computer within a local area network. For example, the mobile device 75 may serve as an aggregator of the various data from the disparate health or fitness monitoring devices, and may be configured to provide these data to a user's home computer via a predetermined communications protocol. Accordingly, in this embodiment the user can receive the data from the various health or fitness monitoring devices without the need to equip her computer to communicate according a plurality of disparate communications protocols. In another embodiment, the data may be transmitted to another mobile device. For example, members of a running team might be equipped with systems as illustrated in FIG. 1, and the mobile devices 75 may upload the collected data to a central mobile device or central location so that the team's progress can be monitored in real time, or analyzed at a later time. As another implementation, the system might be implemented in a clinic or health care environment, and the data generated can be sent to a doctor's or other health care worker's computer to allow them to monitor a patient's health and fitness progress. For example, a rehabilitation clinic's equipment might be equipped with wireless transmitters, and a mobile device 75 might be provided to patients of the clinic to allow their progress during rehabilitation regimens to be monitored.

In the illustrated embodiment, an interface with a website 83 is used to store the data collected from the health or fitness monitoring devices. In various embodiments, this website may be specially created for interoperation with the system, or the system may be configured to interoperate with one or more pre-existing web services. For example, a variety of pre-existing websites may provide users with the ability to store and track their health related data. However, these websites may require that the users manually enter this data, or upload this data in a predetermined format that varies according to the website being used. Accordingly, the application residing on the mobile device 75 may be pre-configured with ability to interface with a variety of pre-existing health tracking websites, and may be updateable to interface with additional health tracking websites. In this manner, the data collected from various health or fitness monitoring devices may be uploaded to different websites or web services at the user's selection without requiring the user to manually manage the data.

In other embodiments, rather than a website, other data storages might be employed. For example, as described above, a locally connected computer, a computer connected to the internet, or a computer on a local area network might receive and store the data. These computers might be equipped with interfacing application that allow the user to view and manage the aggregated data. For example, the mobile device 75 might establish a local connection, for example using a Bluetooth, WiFi, or infrared connection, with a local computer, and the mobile device 75 may be configured to transmit accumulated health or fitness data to the local personal computer through this local connection. As another example, a intranet server located at a medical doctor's practice might be configured to accumulate the aggregated data from a plurality of system users. This server may then be used by the medical doctor to monitor patients who are using the system. Accordingly, a medical doctor may be able to easily determine which patients are following prescribed regimens.

In further embodiments, the system may be further configured to send data to connected health and fitness devices. For example, a health or fitness monitoring device installed on an exercise machine, such as a treadmill, might be configured to be able to receive an uploaded workout profile. In some embodiments, a user can use the methods of data presentation and manipulation provided by the external storage to generate new profiles for such devices. In the implementation described above, the medical doctor could upload new device profiles to a patient's workout equipment, or heart rate monitors, or other health or fitness devices, as the patient's course of treatment progresses. For example, as a patient's heart grew stronger, the doctor could send a command to the system 75 to increase a maximum heart rate alert on the patient's heart rate monitor 79.

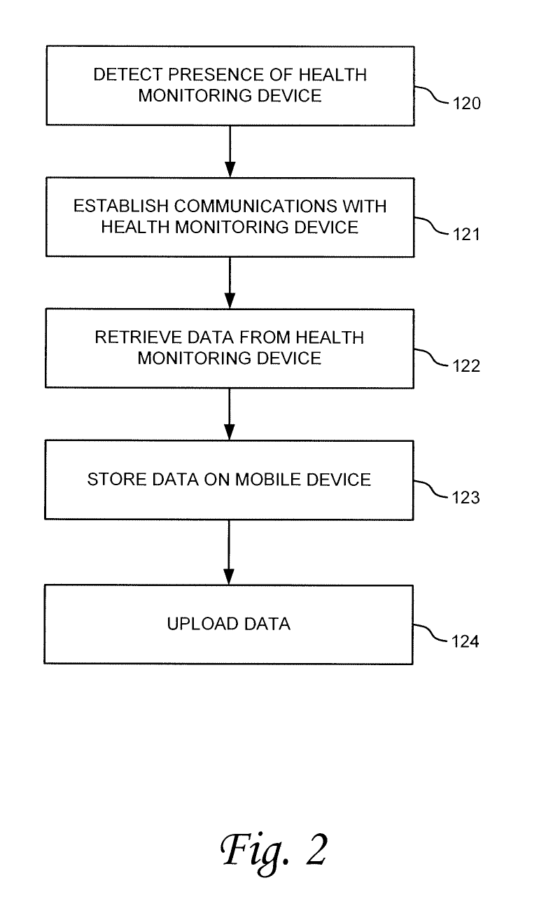

FIG. 2 illustrates a method of system operation according to an embodiment of the invention. In step 120, the mobile device detects the presence of a health or fitness monitoring device within its range. In some embodiments, the mobile device may be configured to use a communications module to transmit probes for health or fitness monitoring devices at predetermined intervals to detect the presence of a health or fitness monitoring device. In other embodiments, the communications module may remain in a receptive state and the health or fitness monitoring device may indicate its presence to the mobile device. In still further embodiments, the mobile device user may indicate the presence of the health or fitness monitoring device, such as through a predetermined user input to an application running on the mobile device.

In step 121, the mobile device establishes a communications session with the health or fitness monitoring device. In some embodiments, for example if the health or fitness monitoring device merely broadcasts its data as it generated, the communication session establishment may comprise simply receiving transmitted data. In other embodiments, for example if multiple health or fitness monitoring devices can communicate with the mobile device simultaneously, the communication session establishment might comprise scheduling data transmission and reception with the health or fitness monitoring device. In still further embodiments, for example if multiple health or fitness monitoring devices will be communicating with the mobile device in a serial manner, the communication session establishment might comprise the health or fitness monitoring device transmitting after an initial request for data is received from the mobile device.

In step 122, the health related data is obtained from the health or fitness monitoring device. In some embodiments, this health related data might comprise telemetry received as it is generated, such as from a continuously broadcasting heart rate monitor. Many health or fitness monitoring devices may be configured as stand alone computers that are equipped to accumulate various and store a variety of statistics and data. In these embodiments, this health related data might comprise data from an entire period or other saved data that was accrued by the health or fitness monitoring device. For example, a fitness watch equipped with a GPS module may be configured to store various data such as traveled routes, and times for completion of those routes. The example fitness watch might also be configured to communicate with other sensors such as a pedometer or a heart rate monitor, and may be configured to accumulate data from these sensors and compile and store the data. Similarly, a cycling computer or a computer built into a spin machine or stationary bicycle may be equipped to communicate with an rpm sensor and a heart rate monitor and be configured to accumulate and compile various data from these sensors during different exercise periods. As another example, a weight scale or glucose meter may be configured to store the results of multiple weighings or blood testings until the data is retrieved from the devices. These health or fitness monitoring devices may be configured to communicate these accumulated or compiled data and statistics to a requesting device. For example, the described fitness watch may be pre-configured to transmit the accumulated data in a predetermined standard format. Accordingly, the step of retrieving the data 122 may configured requesting that the health or fitness monitoring device transmit its accumulated data in its predetermined standard format. In these embodiments, the mobile device may be configured to receive data according to the different formats used by the health or fitness monitoring devices that the mobile device is configured to interface with.

In further embodiments, the health or fitness devices may have a more configurable interfacing system. For example, the health or fitness monitoring device might be configured to upload all data obtained since its last upload, or the health or fitness monitoring device might be configured with a user interface to allow the user to select what data is transferred. As another example, the health or fitness monitoring device might transmit a description of the available data to the mobile device, and the user may select what data to transmit using a user interface on the mobile device. In still further embodiments, the health related data might comprise data aggregated from one or more other devices. For example, a watch or other device might be configured to interface with a plurality of other health or fitness monitoring devices and might be further configured to aggregate data from these other health or fitness monitoring devices. In this embodiment, the mobile device can interface with the data aggregator to retrieve some or all of the aggregated data without being required to interface with the individual other health related devices.

In step 123, the received health related data is stored on the mobile device. In some embodiments, this data storage might comprise a temporary storage while the data is being uploaded in step 124. In other embodiments, the data might be stored for a longer period, such as until the mobile device is in range of an internet connection or until the user chooses to upload the stored data. In still further embodiments, the data might be stored even after it is uploaded, for example to be used to provide a graphic representation of progress or history on the mobile device, or for manipulation. For example, the mobile device may be further configured to determine various fitness metrics, such as body mass index or maximum recommended heart rate, based on the retrieved data and present these measurements to the user through the mobile device, such as through a graphical display of change of such a metric over time.

In step 124, the stored data is uploaded to a predetermined location. In some embodiments, this location might comprise a website on the internet, such as a predetermined, user-selected, website. In other embodiments, the mobile device might be configured to join a LAN and upload the data to a personal computer also connected to the LAN. In still further embodiments, this location might comprise any other network accessible device, for example another mobile device, or a network accessible personal computer.

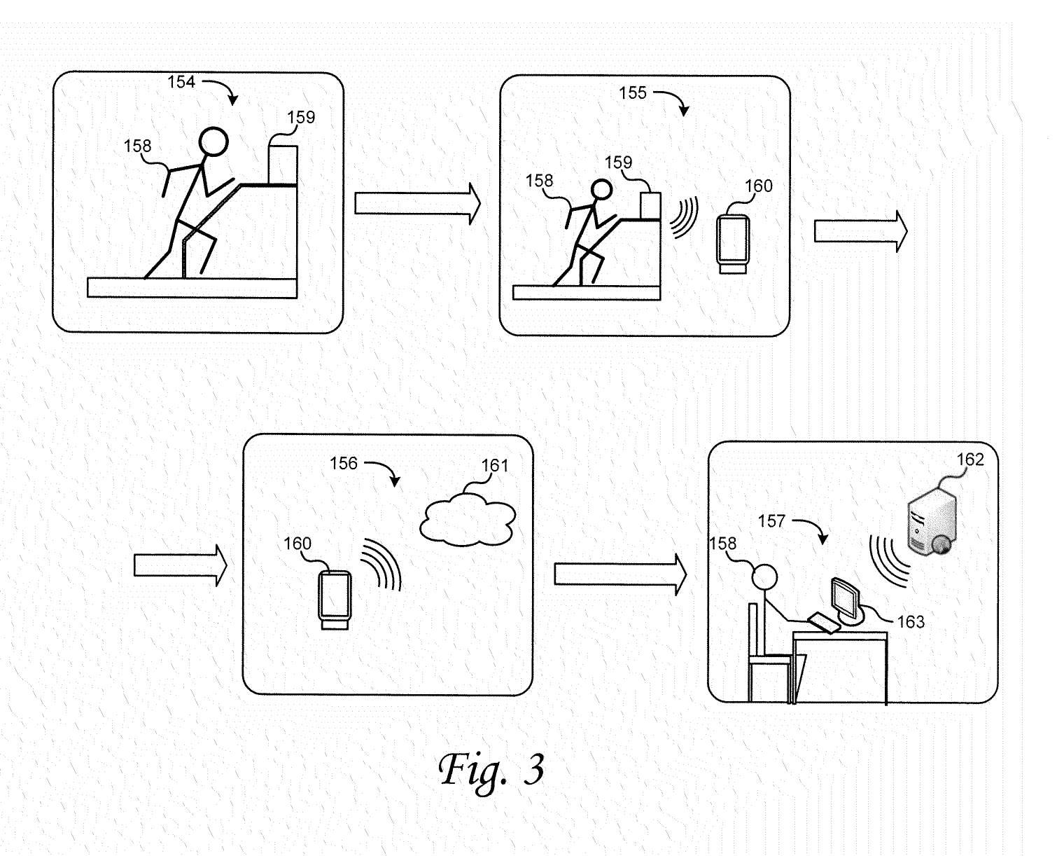

FIG. 3 illustrates an example of system operation in accordance with an embodiment of the invention. In this example, a user 158 generates health data that is stored by a health or fitness monitoring device 159. For example, a treadmill may be configured store data about an exercise period, such as inclination, speed, and duration. In other implementations, this data might be accumulated by different devices before transmitting to mobile device 160. For example, a user 158 might be equipped with a heart rate monitor or other sensor that also has a connection to mobile device 160, or has a connection to another one of the health or fitness monitoring devices 159. Accordingly, the device 159 might accumulate data from other connected devices before transmission to mobile device 160.

After—or while—this data is generated, the health or fitness monitoring device 159 transmits 155 the data to the mobile device 160. The mobile device 160 then transmits 156 the data to a data storage 161 where it is stored for presentation 157 to the user 158. In one embodiment, this data storage may comprise a webserver 162 within the internet and the presentation might occur via a website that is accessible, for example through a personal computer 163 or through the mobile device 160. In other embodiments, the storage 161 might comprise any other location for storage and aggregation of health or fitness related data. For example, it might comprise the personal computer 163, or server hosted on a local intranet.

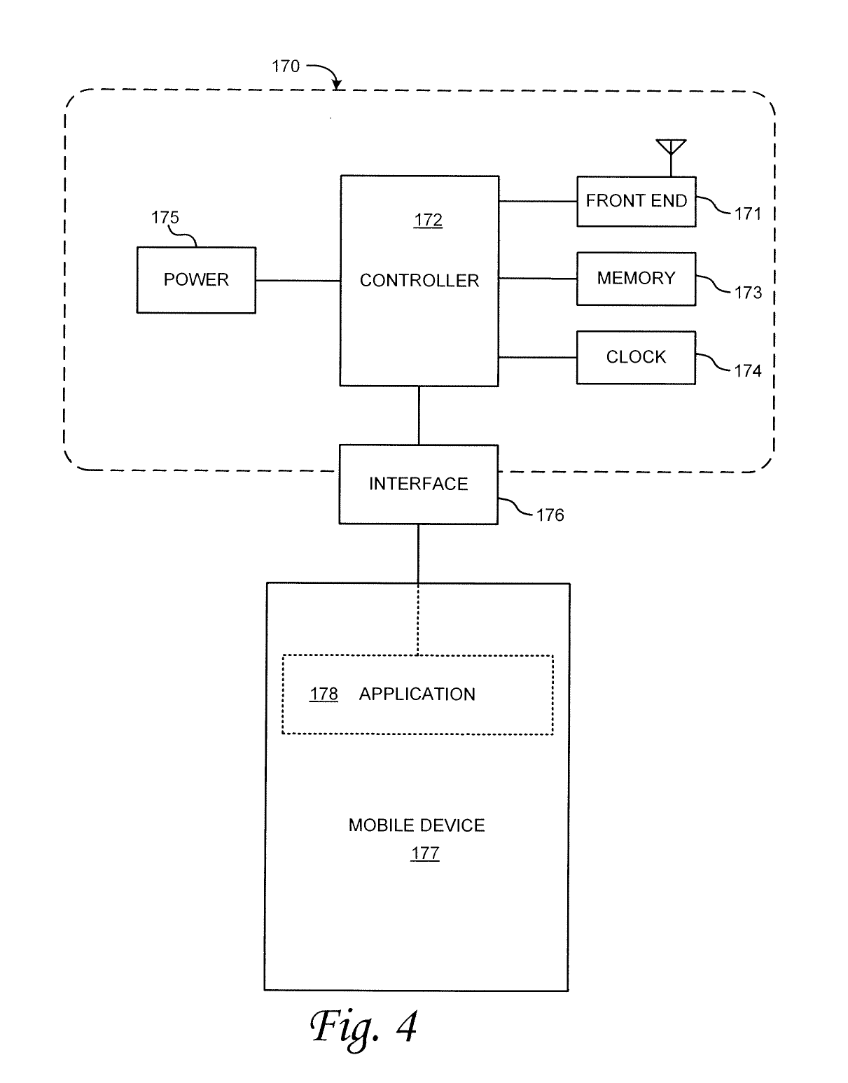

FIG. 4 illustrates a communications module and mobile device configured in accordance with an embodiment of the invention. In this embodiment, an application 178 is installed on mobile device 177 to implement various features and methods described herein. In particular, the application 178 may be configured to interface with a communications module 170 and with the mobile device 177 to act as a bridge between a health or fitness monitoring device and an external network service or device. The illustrated system therefore comprises an application 178 installed on the mobile device 177 and configured to mediate data transfer between communications module 170 and mobile device 177 via interface 176.

The communications module 170 may comprise a wireless antenna and wireless front end module 171. In some embodiments, the communications module 170 may be preconfigured according to one or more predetermined communications standards, and the front end may be configurable to selectively receive wireless signals as transmitted according to the predetermined communications standard. For example, if the predetermined communications standard utilizes 2.4 GHz communications, front end 171 may be configured to receive and filter communications sent at this frequency. A controller module 172 may comprise a digital signal processor, microcontroller, or other programmable logic device that is configured to decode the data from the communications received via the front end module 171. The controller 172 may perform these operations using a clock signal from clock 174 according to protocol software stored on memory 173. In some embodiments, the module may be configured to communicate according to multiple communications standards, such as if disparate communications standards are used by different health or fitness monitoring devices. In these embodiments, communications module 170 may be configured to communicate according to such a plurality of standards and controller 172 or application 178 may be configured to determine which standard to use for communications with the currently paired health or fitness monitoring device.

In some embodiments, the interface 176 may comprise a physical interface with the mobile device 177. For example, the communications module may be present as a component of the mobile device, or the communications module may be housed in a separate housing and may be provided with a plug that plugs into a predetermined jack on the mobile device 177. In these embodiments, the communications module 170 may receive required power via the interface 176 itself. In other embodiments, the interface 176 might comprise a wireless interface, or might comprise a non-powered interface. In these embodiments, a power source 175, such as a battery, may be provided with or coupled to communications module 170.

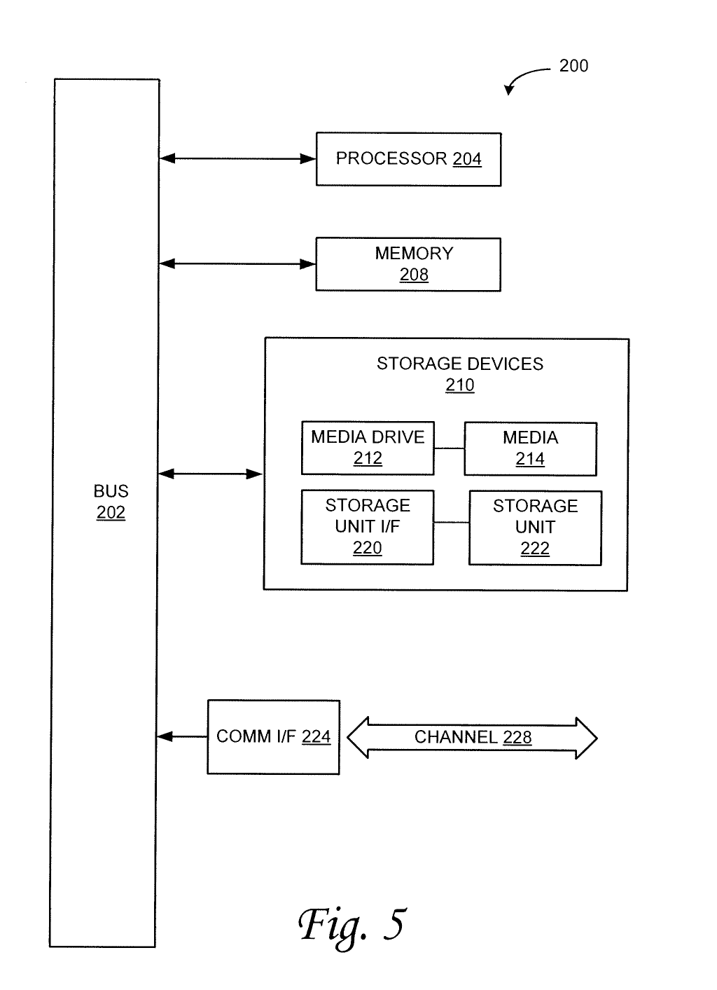

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 200. After reading this description, it will become apparent to a person skilled in the relevant art how to implement the invention using other computing modules or architectures.

Referring now to FIG. 5, computing module 200 may represent, for example, computing or processing capabilities found within desktop, laptop and notebook computers; hand-held computing devices (PDA's, smartphones, cell phones, palmtops, etc.); mainframes, supercomputers, workstations or servers; or any other type of special-purpose or general-purpose computing devices as may be desirable or appropriate for a given application or environment. Computing module 200 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 200 might include, for example, one or more processors, controllers, control modules, or other processing devices, such as a processor 204. Processor 204 might be implemented using a general-purpose or special-purpose processing engine such as, for example, a microprocessor, controller, or other control logic. In the illustrated example, processor 204 is connected to a bus 202, although any communication medium can be used to facilitate interaction with other components of computing module 200 or to communicate externally.

Computing module 200 might also include one or more memory modules, simply referred to herein as main memory 208. For example, preferably random access memory (RAM) or other dynamic memory, might be used for storing information and instructions to be executed by processor 204. Main memory 208 might also be used for storing temporary variables or other intermediate information during execution of instructions to be executed by processor 204. Computing module 200 might likewise include a read only memory (“ROM”) or other static storage device coupled to bus 202 for storing static information and instructions for processor 204.

The computing module 200 might also include one or more various forms of information storage mechanism 210, which might include, for example, a media drive 212 and a storage unit interface 220. The media drive 212 might include a drive or other mechanism to support fixed or removable storage media 214. For example, a hard disk drive, a floppy disk drive, a magnetic tape drive, an optical disk drive, a CD or DVD drive (R or RW), or other removable or fixed media drive might be provided. Accordingly, storage media 214 might include, for example, a hard disk, a floppy disk, magnetic tape, cartridge, optical disk, a CD or DVD, or other fixed or removable medium that is read by, written to or accessed by media drive 212. As these examples illustrate, the storage media 214 can include a computer usable storage medium having stored therein computer software or data.

In alternative embodiments, information storage mechanism 210 might include other similar instrumentalities for allowing computer programs or other instructions or data to be loaded into computing module 200. Such instrumentalities might include, for example, a fixed or removable storage unit 222 and an interface 220. Examples of such storage units 222 and interfaces 220 can include a program cartridge and cartridge interface, a removable memory (for example, a flash memory or other removable memory module) and memory slot, a PCMCIA slot and card, and other fixed or removable storage units 222 and interfaces 220 that allow software and data to be transferred from the storage unit 222 to computing module 200.

Computing module 200 might also include a communications interface 224. Communications interface 224 might be used to allow software and data to be transferred between computing module 200 and external devices. Examples of communications interface 224 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 224 might typically be carried on signals, which can be electronic, electromagnetic (which includes optical) or other signals capable of being exchanged by a given communications interface 224. These signals might be provided to communications interface 224 via a channel 228. This channel 228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 208, storage unit 220, media 214, and channel 228. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the folio of computer programs or other groupings). When executed, such instructions might enable the computing module 200 to perforin features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in tennis of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A computer program product comprising a computer useable medium having computer program code embodied therein for enabling a mobile device to interact with a health or fitness monitoring device, the interaction comprising:
using a communications module to establish a session with the health or fitness monitoring device;
retrieving data from the health or fitness monitoring device during the session;
storing or displaying the data on the mobile device; and
uploading the data to a predetermined network location.

2. The computer program product of claim 1, wherein the communications module comprises a wireless bridge adapter that interfaces with the mobile device, and the health or fitness monitoring device comprises one or more health or fitness monitoring devices or sensors.

3. The computer program product of claim 1, wherein the predetermined network location comprises a website, an internet-connected personal computer, or a local area network location.

4. The computer program product of claim 2, wherein the session comprises a data transfer session established according to a predetermined communications standard.

5. The computer program product of claim 4, wherein the communications module is configured to communicate with a plurality of different health or fitness monitoring devices using a corresponding plurality of different predetermined communications standards.

6. The computer program product of claim 5, wherein data received from different health or fitness monitoring devices is uploaded to different websites according to a user selection.

7. The computer program product of claim 1, wherein the interaction further comprises presenting a representation of the data on the mobile computing device.

8. A communications module usable by a computer program embodied on a computer readable medium within a mobile device, wherein the communications module comprises:
a wireless front end;
a controller;
a memory; and
an interface;
wherein the computer program is configured to cause the mobile device to interact with a health or fitness monitoring device, the interaction comprising:
using the communications module to establish a session with the health or fitness monitoring device;
retrieving data from the health or fitness monitoring device during the session;
storing the data on the mobile device; and
uploading the data to a predetermined network location.

9. The module of claim 8, wherein the communications module comprises a wireless bridge adapter that interfaces with the mobile device, and the health or fitness monitoring device comprises one or more health or fitness monitoring devices or sensors.

10. The module of claim 8, wherein the predetermined network location comprises a website, an interne-connected personal computer, or a local area network location.

11. The module of claim 9, wherein the session comprises a data transfer session established according to a predetermined communications standard.

12. The module of claim 11, wherein the communications module is configured to communicate with a plurality of different health or fitness monitoring devices using a corresponding plurality of different predetermined communications standards.

13. The module of claim 12, wherein data received from different health or fitness monitoring devices is uploaded to different websites according to a user selection.

14. The module of claim 8, wherein the interaction further comprises presenting a representation of the data on the mobile computing device.

15. A method for a mobile device to interact with a health or fitness monitoring device, comprising:
using a communications module to establish a session with the health or fitness monitoring device;
retrieving data from the health or fitness monitoring device during the session;
storing the data on the mobile device; and
uploading the data to a predetermined network location.

16. The method of claim 15, wherein the communications module comprises a wireless bridge adapter that interfaces with the mobile device, and the health or fitness monitoring device comprises one or more health or fitness monitoring devices or sensors.

17. The method of claim 15, wherein the predetermined network location comprises a website, an internet-connected personal computer, or a local area network location.

18. The method of claim 16, wherein the session comprises a data transfer session established according to a predetermined communications standard.

19. The method of claim 18, wherein the communications module is configured to communicate with a plurality of different health or fitness monitoring devices using a corresponding plurality of different predetermined communications standards.

20. The method of claim 19, wherein data received from different health or fitness monitoring devices is uploaded to different websites according to a user selection.
